(19) United States
(12) Patent Application Publication
(10) Pub. No.: US 2012/0124436 A1
(43) Pub. Date: May 17, 2012

(54) SEMICONDUCTOR MEMORY DEVICE PERFORMING PARALLEL TEST OPERATION

(75) Inventors: Tetsuaki OKAHIRO, Chuo-ku (JP); Hiroki FUJISAWA, Chuo-ku (JP)

(73) Assignee: ELPIDA MEMORY, INC., Tokyo (JP)

(21) Appl. No.: 13/289,417

(22) Filed: Nov. 4, 2011

(30) Foreign Application Priority Data
Nov. 11, 2010 (JP) 2010-253244

(51) Int. Cl. G06F 11/20

(52) U.S. Cl. 714/726; 714/E11.079

(57) ABSTRACT

A semiconductor memory device includes: first test circuits each of which operates in a first test mode in which the first test circuit receives a plurality of comparison result signals each indicating a comparison result of storage contents of a plurality of memory cells included in a memory cell array in parallel and generates a first output signal by converting the comparison result signals into serial signals or a second test mode in which the first test circuit generates a second output signal by compressing the data amount of the plurality of comparison result signals. Each of the first test circuits outputs the first and second output signals to a common bus.

### BACKGROUND OF THE INVENTION

1. Field of the Invention

The present invention relates to a semiconductor memory device and, more particularly, to a semiconductor memory device for which a parallel test is performed.

2. Description of Related Art

A read/write test is performed for a semiconductor memory device such as a DRAM (Dynamic Random Access Memory) at its production stage in order to check whether data can be stored properly or not in a memory cell. As the read/write test, a parallel test is used for the purpose of shortening test time. In this parallel test, read/write tests are performed in parallel for a plurality of memory cells, and results of the read/write tests for the memory cells are degenerated by comparison to make the number of test results less than the number of memory cells to be tested. There are two modes in such a parallel test: one is a 2DQ output mode performed in a wafer stage; and the other is a 1DQ output mode used in a screening test after assembly.

In the parallel test, predetermined data (HIGH or LOW) are written into memory cells to be tested before start of the test. In the test execution state, the storage contents of a predetermined number of the memory cells are compared sequentially, and “PASS” is determined when the storage contents coincide, and otherwise “FAIL” is determined.

In the 2DQ output mode, every time the comparison processing of a predetermined number of memory cells is performed, a determination result based on the comparison processing is output in the form of a test result signal. The test result signal of the 2DQ output mode is used for relieving defective memory cells by utilizing a redundant configuration.

The 1DQ output mode is the same as the 2DQ output mode in the point that the test result signal is output every time the comparison processing is performed but differs in the point that when “FAIL” has been determined even once in a series of the comparison processing, all the subsequent test result signals are determined to be “FAIL”. That is, in the 1DQ output mode, if there is only one defective memory cell in the memory cell array, “FAIL” determination is made.

In the parallel test, the memory cell area is divided into a plurality of test areas, and the comparison processing is performed in units of the test areas. As a result, in the 2DQ output mode, a number of test result signals corresponding to the number of the test areas are output every time the comparison processing is performed. For the output, parallel/serial conversion processing that converts the test result signals output in parallel from the respective test areas into serial signals is performed. In the 1DQ output mode, degeneration processing (processing of compressing the data amount) is applied to the test result signals the number of which corresponds to the number of the test areas. As a result, the test result signal output in the 1DQ output mode becomes one-bit data indicating “FAIL” or “PASS” regardless of the number of the test areas.

Japanese Patent Application Laid-Open No. 2001-332086 discloses an example of a test similar to the 1DQ output mode.

In the semiconductor memory device according to the background art, the test areas are arranged in two rows. The area between the two rows is used as a wiring area, and a test circuit performing the parallel/serial conversion processing and degeneration processing is disposed in the wiring area. The test areas and test circuit are connected by a bus.

However, in such a configuration, as the number of the test areas is increased with an increase in the storage capacity of the semiconductor memory device, the number of buses required for the parallel test is increased. In particular, the increase in the number of the buses extending in parallel in the wiring area is unfavorable in terms of the floor plan of the wiring area, so that a reduction in the number of the parallel extending buses for parallel test is required.

### SUMMARY

In one embodiment, there is provided a semiconductor memory device that includes: a plurality of first memory cell arrays; a plurality of first circuit units each provided for a corresponding one of the first memory cell arrays, each of the first circuit units generating a first test result signal relative to the corresponding one of the first memory cell arrays; a first test circuit receiving in parallel the first test result signals from the first circuit units, the first test circuit outputting in series the first test result signals in a first test mode, and the first test circuit operating a logic operation on the first test result signals to generate and output a second test result signal in a second test mode; and a first bus line coupled to the first test circuit, the first bus line receiving, in the first test mode, the first test result signals from the first test circuit and receiving, in the second test mode, the second test result signal from the first test circuit.

In another embodiment, there is provided a semiconductor memory device that includes: a plurality of first memory cell arrays; a plurality of first test groups each including corresponding ones of the first memory cell arrays; a plurality of first test circuits each provided for a corresponding one of the first test groups, each of the first test circuits receiving in parallel first test result signals from the ones of the first memory cell arrays of the corresponding one of the first test groups, outputting in series the first test result signals to a first output node thereof in a first test mode, performing a first logic operation on the first test result signals to produce a second test result signal and outputting the second test result signal to the first output node thereof in a second test mode; and a second test circuit including a plurality of first input nodes coupled respectively to the first output nodes of the first test circuits, the second test circuit outputting, in the first test mode, in series ones of the first test results that are supplied from the first test circuits and performing a second logic operation on the second test result signals that are supplied from the first test circuits to produce a third test result signal and outputting, in the second test mode, the third test result signal.

In still another embodiment, there is provided a semiconductor memory device that includes: a first wiring; and a first test circuit including: a first circuit unit that outputs first signals in time series; a second circuit unit that performs a first logical operation based on the first signals to generate a second signal; and a first selection circuit that receives the first signals and the second signal, wherein the first selection circuit outputs the first signals to the first wiring in time series in a first operation mode, and the first selection circuit outputs the second signal to the first wiring in a second operation mode.

### BRIEF DESCRIPTION OF THE DRAWINGS

FIG. 1 is a block diagram illustrating a configuration of a semiconductor memory device according to a first preferred embodiment of the present invention;

FIG. 2A illustrates the time chart in the case of the 2DQ output mode according to the first embodiment of the present invention;

FIG. 2B illustrates the time chart in the case of the 1DQ output mode according to the first embodiment of the present invention;

FIG. 3 is a circuit diagram illustrating an internal circuit configuration of the comparison circuit shown in FIG. 3;

FIG. 4 is a plan view of the semiconductor memory device according to the first embodiment of the present invention;

FIG. 5 is a circuit diagram illustrating an internal circuit configuration of the test circuit shown in FIG. 4;

FIG. 6 is a plan view of the semiconductor memory device according to a second embodiment of the present invention;

FIG. 7 is a circuit diagram illustrating an internal circuit configuration of the test circuit shown in FIG. 6;

FIG. 8 is a plan view of a semiconductor memory device according to a comparative example; and

FIG. 9 is a circuit diagram illustrating an internal circuit configuration of the test circuit shown in FIG. 8.

### DETAILED DESCRIPTION OF THE EMBODIMENTS

Preferred embodiments of the present invention will be explained below in detail with reference to the accompanying drawings.

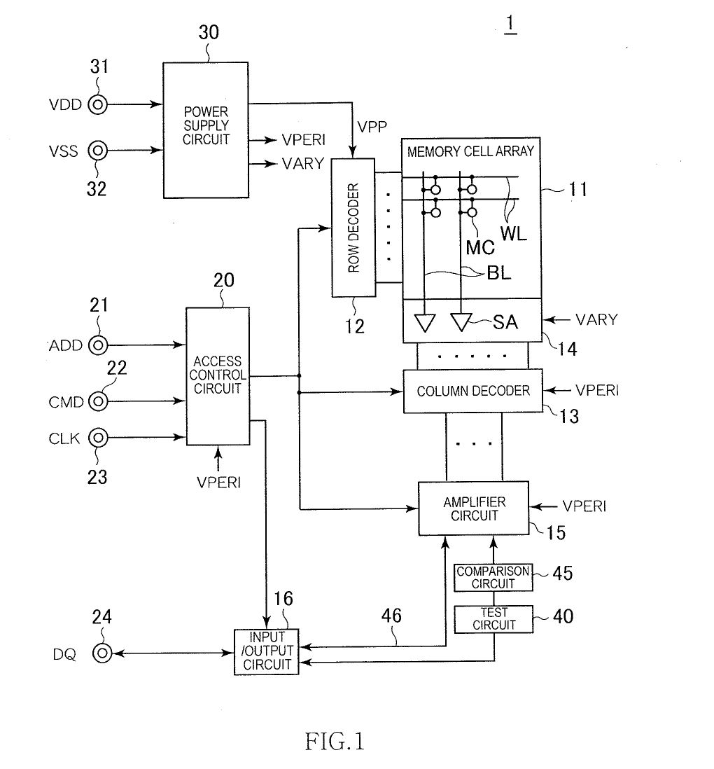

Referring now to FIG. 1, the semiconductor memory device 1 according to the present embodiment is an SDRAM (Synchronous Dynamic Random Access Memory) of a DDR3 (Double Data Rate 3) type and has a memory cell array 11. The memory array 11 has a plurality of word lines WL and a plurality of bit lines BL crossing each other, and a memory cell MC is disposed at each intersection of the word lines WL and bit lines BL. Selection of the word line WL is made by a row decoder 12, and selection of the bit line BL is made by a column decoder 13. The bit lines BL are connected to their corresponding sense amplifiers SA in a sense circuit 14, and the bit line BL selected by the column decoder 13 is connected to an amplifier circuit 15 through the sense amplifier SA.

Operations of the row decoder 12 and column decoder 13 are controlled by an access control circuit 20. The access control circuit 20 receives an address signal ADD and a command signal CMD supplied from outside through an address terminal 21 and a command terminal 22, respectively, and controls the row decoder 12 and column decoder 13 based on the address signal ADD and command signal CMD. Further, the access control circuit 20 controls operation of the amplifier circuit 15.

Concretely, when the command signal CMD indicates active operation, the address signal ADD is supplied to the row decoder 12. In response to this, the row decoder 12 selects a word line WL specified by the address signal ADD, and thereby corresponding memory cells MC are respectively connected to the bit lines BL. When the command signal CMD indicates read operation or write operation, the address signal ADD is supplied to the column decoder 13. In response to this, the column decoder 13 connects a bit line BL specified by the address signal ADD to the amplifier circuit 15. Thus, when the command signal CMD indicates read operation, read data DQ read out from the memory cell array 11 through the sense amplifier SA is output outside from a data input/output terminal 24 through the amplifier circuit 15 and an input/output circuit 16. When the command signal CMD indicates write operation, write data DQ supplied from outside through the data input/output terminal 24 is written into the memory cell MC through the input/output circuit 16, amplifier circuit 15, and sense amplifier SA.

A comparison circuit 45 and a test circuit 40 are provided between the amplifier circuit 15 and input/output circuit 16. The comparison circuit 45 compares the storage contents of the memory cells MC in a parallel test of the memory cell array 11. The test circuit 40 aggregates comparison results for output. The parallel test is a read/write test that checks whether or not data can be read/written properly from/into the memory cells MC by reading data from the memory cell into which predetermined data has previously been written and is performed in a 2DQ output mode (first test mode, first operation mode) performed in a wafer stage or a 1DQ output mode (second test mode, second operation mode) used in a screening test after assembly. Details of the comparison circuit 45, test circuit 40, and parallel test will be described later.

An input/output wiring 46 connecting the amplifier circuit 15 and input/output circuit 16 at normal operation time is provided between the amplifier circuit 15 and input/output circuit 16. When a signal indicating execution of a test mode supplied from the access control circuit 20 is an inactivated level, the amplifier circuit 15 is connected to the input/output circuit 16 through the input/output wiring 46, while when the signal indicating execution of a test mode is an activated level, it is connected to the input/output circuit 16 through the comparison circuit 45 and test circuit 40. The input/output wiring 46 and a path including the comparison circuit 45 and test circuit 40 may be merged into a single common wiring.

Each of The above circuit blocks uses predetermined internal voltage generated by a power supply circuit 30 as an operating power supply. The power supply circuit 30 receives an external potential V_{DD} and a ground potential V_{SS}respectively through power supply terminals 31 and 33 and generates internal voltage V_{PP}, V_{PERI}, V_{ARY,} or the like based on the potentials. Generally, a relationship: V_{PP}>V_{DD}>V_{PERI}≈V_{ARY} is established.

The internal voltage V_{PP} is voltage used in the row decoder 12. The row decoder 12 drives the word line WL selected based on the address signal ADD to the V_{PP} level, thereby turning ON a cell transistor included in the memory cell MC. The internal voltage V_{ARY} is voltage used in the sense circuit 14. When being activated, the sense circuit 14 drives one of the bit line pair to the V_{ARY} level and another one thereof to the V_{SS} level to thereby amplify readout read data. The internal voltage V_{PERI} is used as operating voltage of most of peripheral circuits including the access control circuit 20, etc. By using the internal voltage V_{PERI} lower than the V_{DD} as the operating voltage of the peripheral circuits, a reduction in power consumption is achieved.

Hereinafter, details of the test circuit 40 according to the present embodiment will be described. First, a test circuit and a parallel test according to a related art will be described, and then the test circuit 40 according to the present embodiment will be described.

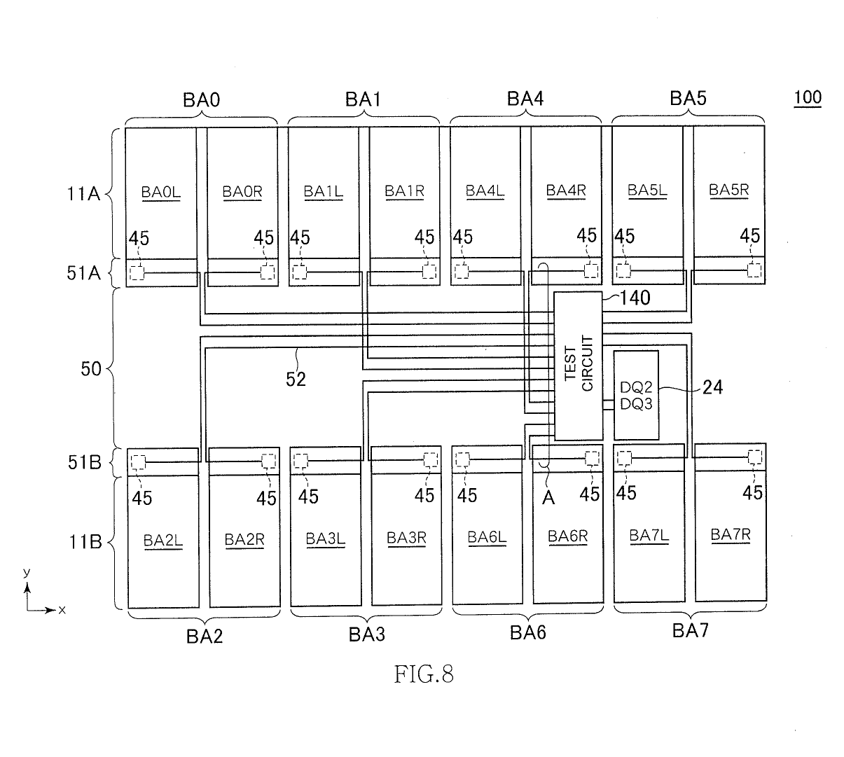

Turning to FIG. 8, the semiconductor memory device 100 is also an SDRAM of a DDR3 type and has a memory cell array 11 of an 8-bank configuration (banks BA0 to BA7). Each of the banks BA0 to BA7 is divided into two areas: L and R, and the parallel test is performed in units of the divided areas (½ banks). This ½ banks are each a test area having a redundant configuration and in which relief of a memory cell that has been determined to be “FAIL” can be completed.

As illustrated in FIG. 8, the memory cell array 11 is divided into two areas: a memory cell area 11A and a memory cell area 11B which are arranged opposite to each other in y-direction. The memory cell area 11A includes test areas BA0L, BA0R, BA1L, BA1R, BA4L, BA4R, BA5L, and BA5R arranged in this order from one end. The memory cell area 11B includes test areas BA2L, BA2R, BA3L, BA3R, BA6L, BA6R, BA7L, and BA7R arranged in this order from one end.

A wiring area 50 is provided between the memory cell areas 11A and 11B. A test circuit 140, a bus or bus line 52, and a data input/output terminal 24 are provided in the wiring area 50. Readout areas 51A and 51B are provided between the memory cell area 11A and wiring area 50 and between the memory cell area 11B and wiring area 50, respectively. In each of the readout areas 51A and 51B, comparison circuits 45 are provided for each test area, and buses 52 extending from the wiring area 50 are provided. Although not illustrated in FIG. 8, an input/output wiring 46 is provided in the wiring area 50.

The test circuit 140 is provided near a space between the test area BA4R and test area BA6R. The buses 52 are provided for each test area and the test circuit 140 is connected to each of the comparison circuits 45 by the corresponding bus 52.

Concretely, each of the buses 52 is wired as follows: Each of the buses 52 is wired so as to extend in x-direction from the test circuit 140 to a position corresponding to a position between L and R of the corresponding bank. Then, the bus 52 is bent at the position so as to extend in y-direction to the readout area 51A (or 51B) and is bent once again at an area between L and R of the corresponding bank so as to be connected to the corresponding comparison circuit 45. With this configuration, 14 buses 52 for parallel test extend in parallel at the most dense portion (portion A in FIG. 8). Although details will be described later, the number of buses for parallel test extending in parallel like this is reduced to eight in the present embodiment.

The buses 52 are also provided between the test circuit 140 and data input/output terminal 24. The test circuit 140 outputs, through the buses 52 and a not illustrated input/output circuit 16, a test result signal using two data input/output terminals 24 in the 2DQ output mode while outputs the test result signal using one of the two data input/output terminals 24 in the 1DQ output mode. Hereinafter, the two data input/output terminals 24 used in the 2DQ output mode are referred to as “data input/output terminals DQ2 and DQ3”, and it is assumed that, in the 1DQ output mode, the test result signal is output using the data input/output terminal DQ3.

A procedure for the parallel test will be described referring to the abovementioned test circuit 140. The parallel test execution procedure as described below is the same as the parallel test performed in the test circuit 40 of the present embodiment.

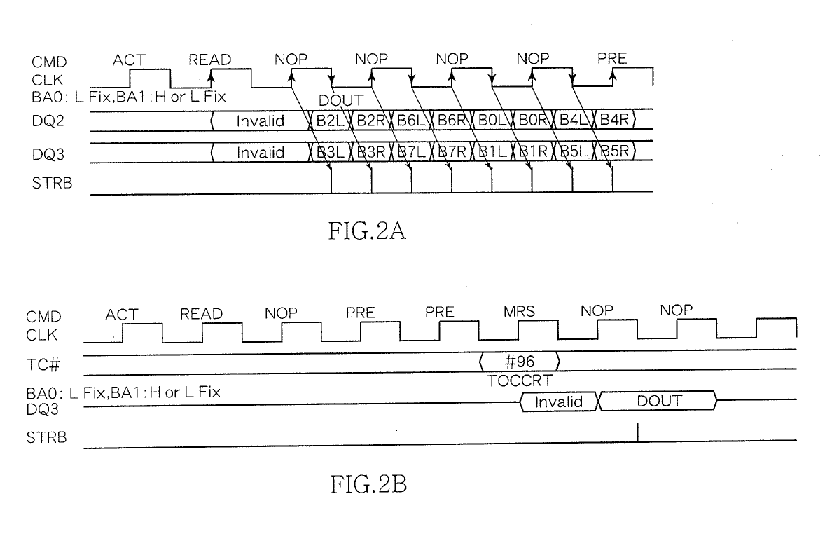

FIGS. 2A and 2B are time charts of various signals used in the parallel test. Before execution of the parallel test, predetermined data (HIGH or LOW) is previously written into the memory cells to be tested. FIG. 2 illustrates the time chart of various signals used in reading the data that has thus been written.

A description will be made focusing on the readout time. First, a command (parallel test execution command) instructing execution of the parallel test is input from an external tester, and the access control circuit 20 of FIG. 1 generates an internal signal instructing execution of the parallel test. Then, as illustrated in FIGS. 2A and 2B, an act command ACT is input from the external tester and, at the same time, an address signal ADD specifying a row address is input. Subsequently, a read command READ is input from the external tester and, at the same time, an address signal ADD specifying a column address is input. By the row address, bank address, and column address thus specified, a plurality of memory cells to be tested are identified for each test area. Note that, since the parallel test according to the present embodiment employs a configuration in which determination of the bank address is not made, it is not necessary to supply the bank address with the act command ACT and read command READ.

After the plurality of memory cells to be tested have been identified, the comparison circuits 45 compare the storage contents of the plurality of memory cells to be tested in the corresponding test areas. Then, each of the comparison circuits 45 generates a comparison result signal indicating “PASS” or “FAIL” based on the comparison result and outputs the comparison result signal to the test circuit 140 through the corresponding bus 52. The processing up to this stage is common to both the 2DQ output mode and 1DQ output mode.

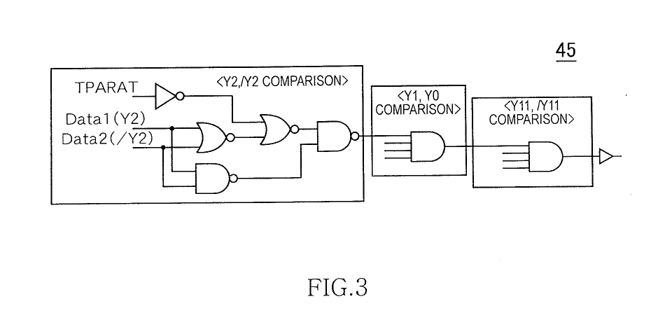

Turning to FIG. 3, a signal TPARAT is a parallel test enable signal indicating the activation of the parallel test and is activated by the access control circuit 20 in response to the input of the abovementioned parallel test execution command.

As illustrated in FIG. 3, operation of the comparison circuit 45 is performed in three stages of Y2, /Y2 comparison, Y1, Y0 comparison, and Y11, /Y11 comparison. In the first stage comparison operation (Y2,/Y2 comparison), data Data1 stored in the memory cell to be tested identified by a column address Y2 and data Data2 stored in the memory cell to be tested identified by a column address /Y2 are compared. The output of the first-stage comparison operation becomes LOW only when the parallel test enable signal is activated and the data Data1 and data Data2 do not coincide with each other and, otherwise, HIGH.

In the second-stage comparison operation (Y1, Y0comparison), comparison results obtained in the first-stage comparison operation are compared. Further, in the third-stage comparison operation (Y11, /Y11 comparison), comparison results obtained in the second-stage comparison operation are compared. Then, the output of the third-stage comparison operation is output from the comparison circuit 45 as the comparison result signal.

With the above configuration, the comparison result signal becomes HIGH when the plurality of memory cells to be tested in the test area store the same data, that is, when all the memory cells do not show any defects and, otherwise, LOW. Accordingly, the comparison result signal is a binary signal indicating “PASS” as HIGH and “FAIL” as LOW.

In the parallel test, all the memory cells MC in the memory cell array 11 are subject to the test. Thus, the above identification of the memory cell to be tested and comparison processing therebetween are repeatedly performed until the tests for all memory cells are finished.

The test circuit 140 receives the comparison result signals from the comparison circuits 45 and generates a test result signal indicating a result of the parallel test according to one of the 2DQ output mode and 1DQ output mode. The operation mode of the test circuit 140 is specified by the access control circuit 20 according to a test code input from an external tester.

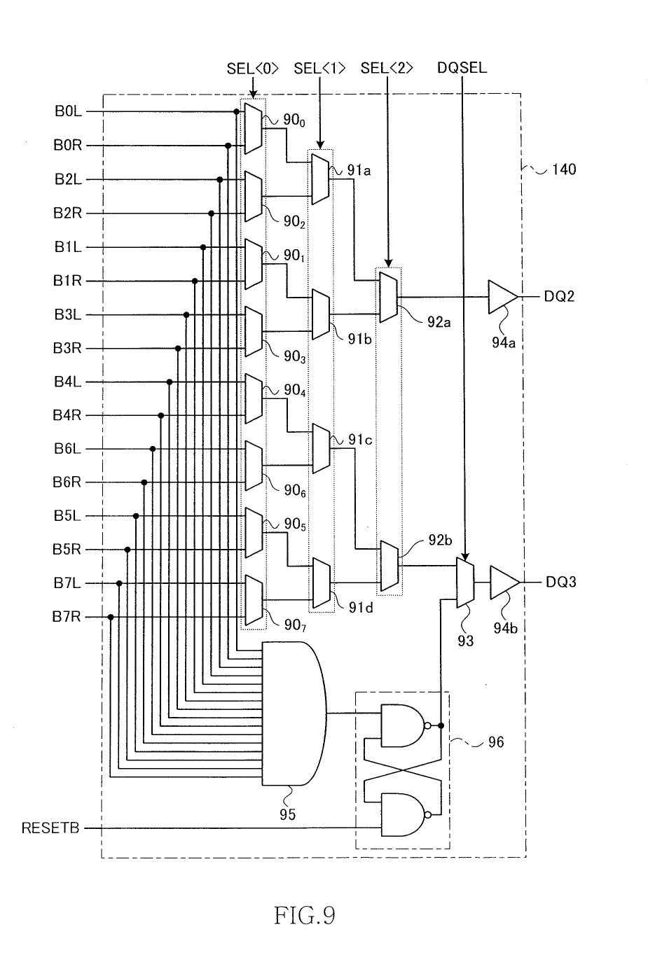

A detailed internal configuration of the test circuit 140 will be described. FIG. 9 is a circuit diagram illustrating an internal circuit configuration of the test circuit 140 according to the comparative example. As illustrated, the test circuit 140 according to the comparative example has multiplexers 90₀ to 90₇, 91a to 91d, 92a, and 92b, a selector or selector circuit 93, buffers 94a and 94b, an AND circuit 95, and a latch circuit 96.

The multiplexer 90ₙ (n is an integer from 0 to 7) is provided corresponding to the bank BAn illustrated in FIG. 8. Comparison result signals BnL and BnR are input in parallel to the multiplexer 90ₙ from the two comparison circuits 45 corresponding to the two test areas BAnL and BAnR in the corresponding bank BAn. Further, a select signal SEL<0>is input to the multiplexer 90ₙ. The select signal SEL<m>(m is an integer from 0 to 2) is a one-shot signal activated in response to the abovementioned read command READ, and the activation timings of the select signals 0 to 2 are shifted in increments of one clock. The multiplexer 90ₙ converts the input comparison result signals BnL and BnR into serial signals and outputs the serial signals at a timing indicated by the select signal SEL<0>. “To convert a plurality of parallel signals into serial signals” has the same meaning as “to apply time-division multiplex to the plurality of signals”.

Similarly, the multiplexers 91a to 91d receive in parallel the outputs of the multiplexers 90₀, 90₂, multiplexers 90₁, 90₃, multiplexers 90₄, 90₉, and multiplexers 90₅, 90₇, respectively, then convert them into serial signals, and output the serial signals at a timing indicated by a select signal SEL<1>. The multiplexers 92a and 92b receive in parallel the outputs of the multiplexers 91a, 91b and multiplexers 91c, 91d, respectively, then convert them into serial signals, and output the serial signals at a timing indicated by a select signal SEL<2>.

The output of the multiplexer 92a is reshaped by the buffer 94a and is then output outside from the data input/output terminal DQ2. On the other hand, the output of the multiplexer 92b is supplied to the multiplexer 93.

The comparison result signals BnL and BnR are all input to the AND circuit 95. When all the signals BnL and BnR indicate HIGH (“PASS”) , the AND circuit 95 outputs HIGH and, otherwise, LOW.

The output of the AND circuit 95 and a reset signal RESETB are input to the latch circuit 96. The reset signal RESETB is a low active one-shot signal input from the external tester at the start time of the parallel test. The output of the latch circuit 96 is reset to LOW in response to the activation of the reset signal RESETB. After the reset, the latch circuit 96 maintains a LOW output while a HIGH is input thereto from the AND circuit 95. When receiving a LOW from the AND circuit 95 even once, the latch circuit 96 maintains a HIGH output afterwards. Thus, the HIGH output of the latch circuit 96 corresponds to “FAIL” determination in the 1DQ output mode, and LOW output thereof corresponds to “PASS” determination in the 1DQ output mode.

The selector 93 receives the output of the multiplexer 92b and output of the latch circuit 96 and selects the output of the multiplexer 92b in the 2DQ output mode while selects the output of the latch circuit 96 in the 1DQ output mode for output to the buffer 94b. An illustrated signal DQSEL is a mode specification signal which is specified by the access control circuit 20 according to a test code input from the external tester, and the operation mode of the selector 93 is specified by the mode specification signal DQSEL. The buffer 94b reshapes the output signal of the selector 93 and outputs the resultant signal from the data input/output terminal DQ2.

With the above configuration, a test result signal DOUT illustrated in FIGS. 2A and 2B is output to the data input/output terminals DQ2 and DQ3. As illustrated in FIGS. 2A and 2B, the test result signal DOUT in the 2DQ output mode is data obtained by applying time-division multiplex to the comparison result signals BnL and BnR. More specifically, the comparison result signals BnL and BnR are burst-output eight by eight at a half-clock interval from the data input/output terminals DQ2 and DQ3, respectively. On the other hand, the test result signal DOUT in the 1DQ output mode is one-bit data. This one-bit data indicates “FAIL” determination if there is even one memory cell that stores different data from other memory cells in the ongoing parallel test (from the start time of the parallel test to time at which tests for all memory cells have been finished) and, otherwise, “PASS” determination. The output test result signal DOUT is fetched into an external tester in time with the activation timing of a data strobe signal STRB illustrated in FIG. 2.

Hereinafter, the test circuit 40 according to the present embodiment will be described.

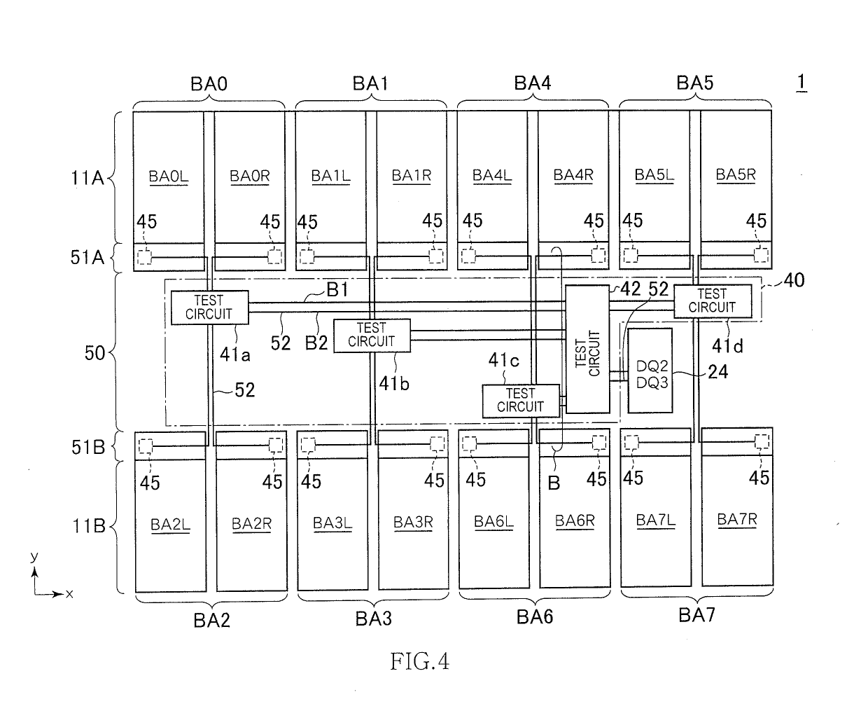

Turning to FIG. 4, the semiconductor memory device 1 also has a memory cell array 11 of an 8-bank configuration (banks BA0 to BA7). The point that each of the banks BA0 to BA7 is divided into two areas: L and R and that the parallel test is performed in units of the divided areas (½ banks) and arrangements of the test areas, comparison circuits 45, and data input/output terminals DQ2 and DQ3 are the same as those in the semiconductor memory device 100 according to the comparative example.

The test circuit 40 of the semiconductor memory device 1 according to the present embodiment includes test circuits 41a to 41d (first test circuit) and a test circuit 42 (second test circuit). These circuits are all provided in the wiring area 50. The position of the test circuit 42 is the same as that of the test circuit 140 according to the comparative example.

To each of the test circuits 41a to 41d, a plurality of test areas differing from each other are assigned. Concretely, the test areas BA0L, BA0R, BA2L, and BA2R are assigned to the test circuit 41a, the test areas BA1L, BA1R, BA3L, and BA3R are assigned to the test circuit 41b, the test areas BA4L, BA4R, BA6L, and BA6R are assigned to the test circuit 41c, and the test areas BA5L, BA5R, BA7L, and BA7R are assigned to the test circuit 41d.

Unlike the case of the test circuit 42, the test circuits 41a to 41d are disposed near their corresponding test areas. Concretely, the test circuit 41a is disposed between the test areas BA0L and BA0R (between the test areas BA2L and BA2R) as viewed in x-direction. Similarly, the test circuit 41b is disposed between the test areas BA1L and BA1R (between the test areas BA3L and BA3R) as viewed in x-direction. The test circuit 41c is disposed between the test areas BA4L and BA4R (between the test areas BA6L and BA6R) as viewed in x-direction. The test circuit 41d is disposed between the test areas BA5L and BA5R (between the test areas BA7L and BA7R) as viewed in x-direction. The test circuit 42 is disposed nearer to the data input/output terminal 24 than in the case of the test areas 41a to 41d.

The test circuit 41a is connected to the four comparison circuits 45 corresponding to the test areas BA0L, BA0R, BA2L, and BA2R assigned thereto through one of the buses 52 each. Similarly, the test circuit 41b is connected to the four comparison circuits 45 corresponding to the test areas BA1L, BA1R, BA3L, and BA3R assigned thereto through one of the buses each. The test circuit 41c is connected to the four comparison circuits 45 corresponding to the test areas BA4L, BA4R, BA6L, and BA6R assigned thereto through one of the buses 52 each. The test circuit 41d is connected to the four comparison circuits 45 corresponding to the test areas BA5L, BA5R, BA7L, and BA7R assigned thereto through one of the buses 52 each. The abovementioned comparison result signals are input to each of the test circuits 41a to 41d from the corresponding four comparison circuits 45 through the buses 52.

The buses 52 connecting the test circuits 41a to 41d and comparison circuits 45 extend in y-direction from the corresponding test circuits 41a to 41d to the readout areas 51A and 51B and are bent at the region between L and R of the banks to be connected to the corresponding comparison circuits 45.

The test circuits 41a to 41d are each connected to the test circuit 42 through the buses 52 the number of which is less than the number of the assigned test areas. Concretely, each of the test circuits 41a to 41d is connected to the test circuit 42 through two buses 52. The buses 52 connecting the test circuits 41a to 41d and test circuit 42 linearly extend in x-direction. The test circuit 42 is connected to the data input/output terminal 24 (data input/output terminals DQ2 and DQ3) through the input/output circuit 16 (not illustrated).

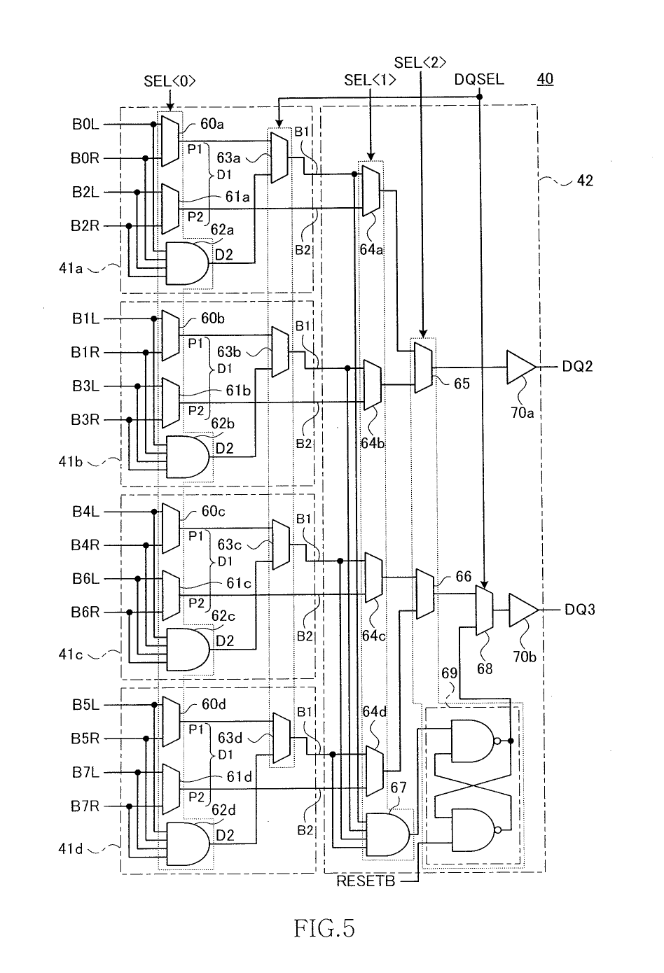

Turning to FIG. 5, the test circuit 41k (k is one of a, b, c, and d) has a multiplexer 60k (first circuit unit), a multiplexer 61k (third circuit unit), an AND circuit 62k (second circuit unit), and a selector 63k (first selection circuit). The test circuit 42 has multiplexers 64a to 64d, a multiplexer 65, a multiplexer 66, an AND circuit 67, a selector 68, a latch circuit 69, and output buffers 70a and 70b. In FIG. 5, the two buses 52 connecting the test circuit 41k and test circuit 42 are represented as a bus B1 (first wiring) and a bus B2 (second wiring).

First, a configuration within the test circuit 41k will be described. Each of the multiplexer 60k and multiplexer 61k generates first output signal D1 for output by converting a plurality of comparison result signals input in parallel into serial signals. In other words, each of the multiplexer 60k and multiplexer 61k outputs the plurality of comparison result signals input in parallel as time-series data. Concretely, the multiplexer 60k generates a first partial output signal P1 by converting a part (first signal) of the plurality of comparison result signals input in parallel into serial signals, and multiplexer 61k generates a second partial output signal P2 by converting the remaining comparison result signals (third signal) input in parallel into serial signals. The first output signal D1 is composed of the thus generated first and second partial output signals P1 and P2.

A description will be given with a concrete example taken. The multiplexer 60a generates the first partial output signal P1 by converting the comparison result signals B0L and B0R into serial signals, and multiplexer 61a generates the second partial output signal P2 by converting the comparison result signals B2L and B2R into serial signals. The same goes for the multiplexers other than the multiplexers 60a and 61a.

Each of the multiplexer 60k and multiplexer 61k outputs the generated signal to a circuit of the subsequent stage at a timing indicated by the abovementioned select signal SEL<0>. Concretely, the multiplexer 60k outputs the generated first partial output signal P1 to the selector 63k, and the multiplexer 61k outputs the generated second partial output signal P2 to the bus B2.

The AND circuit 62k is a circuit generating a second output signal D2 (degenerated signal, second signal) by compressing the data amount of the plurality of comparison result signals input in parallel. The compression of the data amount is achieved by calculating the logical AND (first logical operation) of the comparison result signals. That is, the second output signal D2 is a logical AND signal of the corresponding comparison result signals.

Concretely, the AND circuit 62a calculates the logical AND of the parallel input comparison result signals B0L, B0R, B2L, and B2R and thereby generates the second output signal D2 which is the logical AND signal of the comparison result signals. The same goes for the AND circuits other than the AND circuit 62a.

The second output signal D2 output from the AND circuit 62k is input to the corresponding selector 63k at a timing indicated by the select signal SEL<0>.

The selector 63k outputs the first partial output signal P1 input thereto from the multiplexer 60k to the corresponding bus B1 in the 2DQ output mode, while outputs the second partial output signal D2 input thereto from the AND circuit 62k to the corresponding bus B1 in the 1DQ output mode. The operation mode of the selector 63k is specified by the abovementioned mode specification signal DQSEL supplied from the external tester.

Next, a configuration of the test circuit 42 will be described. The multiplexers 64a to 64d are provided corresponding to the test circuits 41a to 41d, respectively. Each of the multiplexers 64a to 64d receives the first output signal D1 (first and second partial output signals P1 and P2) input in parallel from the corresponding test circuits through the buses B1 and B2 and converts the received parallel signals into serial signals. Then, each of the multiplexers 64a to 64d outputs the data obtained by the conversion to a circuit of the subsequent stage at a timing indicated by the abovementioned select signal SEL<1>.

The multiplexer 64a to 64d are provided for the 2DQ output mode. In the case where the test circuit 40 is in the 1DQ output mode, the second output signal D2 is input to each of the multiplexers 64a to 64d; however, the output of each of the multiplexers 64a to 64d in this case has no special meaning.

The multiplexer 65 converts signals input in parallel from the multiplexers 64a and 64b into serial signals and outputs the serial signals to a circuit of the subsequent stage at a timing indicated by the abovementioned select signal SEL<2>. Similarly, the multiplexer 66 converts signals output in parallel from the multiplexers 64c and 64d into serial signals and outputs the serial signals to a circuit of the subsequent stage at a timing indicated by the abovementioned select signal SEL<2>.

The output signal of the multiplexer 65 is reshaped by the buffer 70a and is then output outside from the data input/output terminal DQ2. The output signal of the multiplexer 66 is input to the selector 68.

The AND circuit 67 compresses the data amount of the second output signals D2 input in parallel from the test circuits 41a to 41d. The compression of the data amount in this case is also achieved by calculating the logical AND (third logical operation) of the second output signals D2 in the same manner as the AND circuits 62k. That is, the output of the AND circuit 67 is a logical AND signal of the second output signals D2. The output signal of the AND circuit 67 is input to the latch circuit 69 at a timing indicated by the select signal SEL<1>.

The AND circuit 67 is provided for the 1DQ output mode, In the case where the test circuit 40 is in the 2DQ output mode, the first partial output signals P1 are input to the AND circuit 37; however, the output of the AND circuit 67 in this case has no special meaning.

The output signal of the AND circuit 67 and abovementioned rest signal RESETB are input to the latch circuit 69. After the reset made by the reset signal RESETB, the latch circuit 69 maintains a LOW output while a HIGH output is input thereto from the AND circuit 67. When receiving a LOW output from the AND circuit 67 even once, the latch circuit 69 maintains a HIGH output afterwards. Thus, the HIGH output of the latch circuit 69 corresponds to “FAIL” determination in the 1DQ output mode, and LOW output thereof corresponds to “PASS” determination in the 1DQ output mode. The output signal of the latch circuit 96 is input to the selector 68 at a timing indicated by the select signal SEL<2>.

The selector 68 outputs the output signal of the multiplexer 66 to the buffer 70b in the 2DQ output mode, while outputs the output signal of the latch circuit 69 to the buffer 70b in the 1DQ output mode. The operation mode of the selector is specified by the abovementioned mode specification signal DQSEL supplied from the external tester. The buffer 70b reshapes the output signal of the selector 68 and outputs the resultant signal to the data input/output terminal DQ3.

With the above configuration, in the 2DQ output mode, the comparison result signals BnL and BnR output in units of the test areas are converted from a plurality of parallel signals into two-channel serial signals by the multiplexers 60a to 60d, 61a to 61d, 64a to 64d, 65, and 66. The serially converted comparison result signals BnL and BnR are burst-output from the data input/output terminals DQ2 and DQ3 as the test result signal DOUT as illustrated in FIG. 2A.

In the 1DQ output mode, the data amount of the comparison result signals is compressed into one bit by the AND circuits 62a to 62d and 67. Then, the compressed signal is output from the data input/output terminal DQ3 as the test result signal DOUT as illustrated in FIG. 2B. The test result signal DOUT actually output is a signal indicating “FAIL” determination if there is even one comparison result signal that has been determined to be “FAIL” after the start of the parallel test. This is achieved by the existence of the latch circuit 69.

As described above, according to the semiconductor memory device 1 of the present embodiment, the first and second output signals D1 and D2 are output to the common bus B1. Thus, the number of the buses extending in parallel in the wiring area can be reduced as compared to a case where the configuration according to the present embodiment is not employed.

Further, the total number of the buses 52 for parallel test to be provided between the test circuits 41a to 41d and test circuit 42 can be reduced to eight, which is the half the number (=16) of the buses for parallel test provided for connecting the test areas and test circuit 140 in the comparative example. As a result, also at the most dense portion (portion B in FIG. 4) in the wiring area, the number of the buses 52 for parallel test extending in parallel is reduced to eight, thus achieving a reduction in the number of the buses 52.

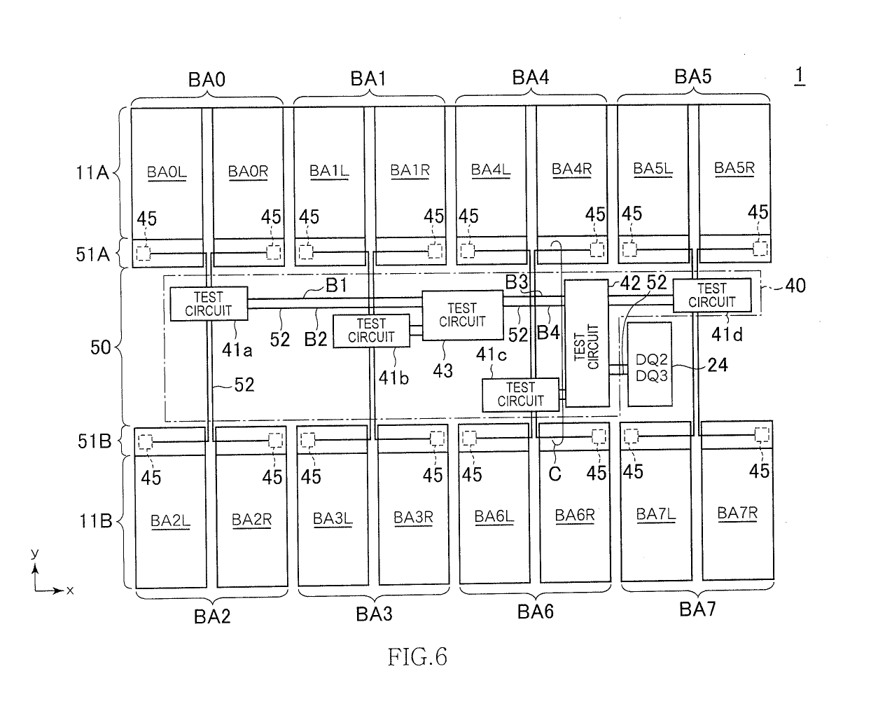

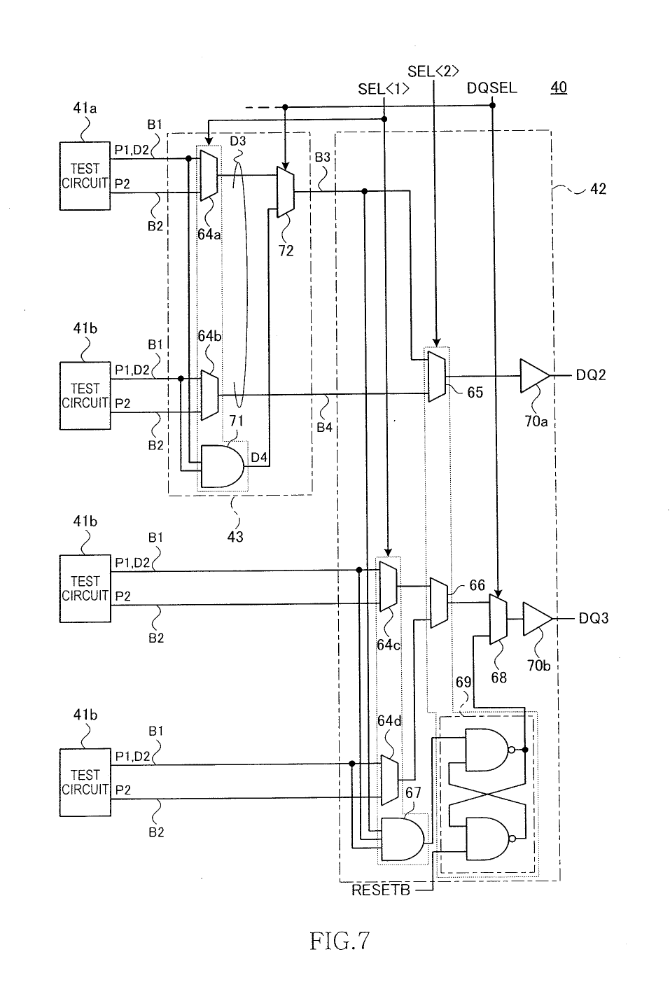

Hereinafter, the second embodiment of the present invention will be described with reference to FIGS. 6 and 7.

As illustrated in FIGS. 6 and 7, the semiconductor memory device 1 according to the present embodiment differs from the semiconductor memory device 1 according to the first embodiment in that it has a test circuit 43 (third test circuit) and that a part of circuit elements of the test circuit 42 are transferred to the test circuit 43. Hereinafter, a description will be made focusing on the different points.

Two or more of the test circuits 41a to 41d are assigned to the test circuit 43. In the example illustrated in FIGS. 6 and 7, the test circuits 41a and 41b are assigned to the test circuit 43. Hereinafter, a description will be made under this assumption.

The test circuit 43 is provided between the test circuits 41a, 41b assigned thereto and test circuit 42. The test circuit 43 is connected to each of the test circuits 41a and 41b by the two buses 52 (buses B1 and B2). The test circuit 42 and test circuit 43 are connected to each other by the two buses 52 (buses B3 and B4, third wiring) for parallel test. The number (two) of the buses 52 for parallel test used to connect the test circuit 42 and test circuit 43 is less than the total number (four) of the buses 52 for parallel test used to output the first output signal by the test circuits 41a and 41b. The buses B3 and B4 each linearly extend in x-direction.

As illustrated in FIG. 7, the test circuit 43 has the multiplexers 64a and 64b (fourth circuit unit) transferred from the test circuit 42, an AND circuit 71 (fifth circuit unit), and a selector 72 (second selection circuit).

The roles of the multiplexers 64a and 64b are the same as those of the multiplexers 64a and 64b of the first embodiment. That is, the multiplexers 64a and 64b are provided corresponding to the test circuits 41a and 41b, respectively, and each of them receives the first and second partial output signals P1 and P2 (fourth signal) output in parallel from the corresponding test circuits through the buses B1 and B2. Then, each of the multiplexers 64a and 64b generates a third output signal D3 by converting the received parallel signals into serial signals and outputs the third output signal D3 to a circuit of the subsequent stage at a timing indicated by the abovementioned select signal SEL<1>.

The third output signal D3 output from the multiplexer 64a is input to the selector 72. The third output signal D3 output from the multiplexer 64b is input to the multiplexer 65 provided in the test circuit 42 through the bus B3.

The AND circuit 71 generates a fourth output signal D4 (degenerated signal, fifth signal) by compressing further the data amount of the second output signals D2 (fourth signal) input in parallel from the corresponding test circuits 41a and 41b. In other words, the AND circuit 71 regenerates a degenerated signal obtained by compressing the data amount of the comparison result signals. The compression of the data amount in this case is achieved by calculating the logical AND (second logical operation) of the second output signals D2, as in the case of the AND circuit 67. That is, the output of the AND circuit 71 is a logical AND signal of the second output signals D2. The fourth output signal D4 output from the AND circuit 71 is input to the selector 72 at a timing indicated by the select signal SEL<1>.

The selector 72 outputs the output signal of the multiplexer 64a to the multiplexer 65 through the bus B3 in the 2DQ output mode, while outputs the output signal of the AND circuit 71 to the multiplexer 65 in the test circuit 42 through the bus B3 in the 1DQ output mode. The operation mode of the selector 72 is specified by the abovementioned mode specification signal DQSEL supplied from the external tester.

The processing performed in the circuits within the test circuit 42 are substantially the same as those in the first embodiment but differs in that the signals input to the AND circuit 67 (sixth circuit unit) are changed to the second output signals D2 (second signal) from the test circuits 41c, 41d and fourth output signal (fifth signal) from the test circuit 43. However, the signal (sixth signal) output from the AND circuit 67 turns out to be the same as that in the first embodiment.

With the above configuration, also in the semiconductor memory device 1 according to the present embodiment, the same test result as that in the first embodiment can be obtained. Further, according to the semiconductor memory device 1 of the present embodiment, the number of the buses 52 for parallel test extending in parallel in the wiring area 50 can be reduced further as compared to the semiconductor memory device 1 according to the first embodiment.

That is, as illustrated in FIG. 6, in the present embodiment, the four buses B1, B2 (two buses B1 and two buses B2) corresponding to the test circuits 41a and 41b are aggregated to the two buses B3, B4 (one bus B3 and one bus B4). As a result, also at the most dense portion (portion C in FIG. 6) in the wiring area, the number of the buses 52 for parallel test extending in parallel is reduced to six, thus achieving a reduction in the number of the buses 52.

It is apparent that the present invention is not limited to the above embodiments, but may be modified and changed without departing from the scope and spirit of the invention.

What is claimed is:

1. A device comprising:
a plurality of first memory cell arrays;
a plurality of first circuit units each provided for a corresponding one of the first memory cell arrays, each of the first circuit units generating a first test result signal relative to the corresponding one of the first memory cell arrays;
a first test circuit receiving in parallel the first test result signals from the first circuit units, the first test circuit outputting in series the first test result signals in a first test mode, and the first test circuit operating a logic operation on the first test result signals to generate and output a second test result signal in a second test mode; and
a first bus line coupled to the first test circuit, the first bus line receiving, in the first test mode, the first test result signals from the first test circuit and receiving, in the second test mode, the second test result signal from the first test circuit.

2. The device as claimed in claim 1, wherein the first test circuit includes a first multiplexer converting the first test result signals from in parallel to in series, a first logic circuit performing the logic operation on the first test result signals to generate the second test result signal and a selector circuit, and the selector circuit includes first and second input nodes coupled respectively to output nodes of the first multiplexer and the first logic circuit and an output node coupled to the first bus line.

3. The device as claimed in claim 2, wherein the selector circuit of the first test circuit receives a test signal at a control node thereof, the selector circuit outputs the first test result signals supplied in series from the first multiplexer to the first bus line during a first period of time when the test signal takes a first logic level, and the selector circuit outputs the second test result signal supplied from the first logic circuit to the first bus line during the second period of time when the test signal takes a second logic level.

4. The device as claimed in claim 1, further comprising:
a plurality of second memory cell arrays;
a plurality of second circuit units each provided for a corresponding one of the second memory cell arrays, each of the second circuit units generating a third test result signal relative to the corresponding one of the second memory cell arrays;
a plurality of second test circuits each provided for an associated ones of the second circuit units, each of the second test circuits receiving in parallel ones of the third test result signals from the associated ones of second circuit units, the each of the second test circuits outputting in series the ones of the third test result signals in the first test mode, and the each of the second test circuits operating a logic operation on the ones of the third test result signals to generate and output a fourth test result signal in the second test mode;
a plurality of second bus lines each coupled to a corresponding one of the second test circuits, each of the second bus lines receiving, in the first test mode, the ones of the third test result signals from the corresponding one of the second test circuit and receiving, in the second test mode, the fourth test result signal from the corresponding one of the second test circuits;
a data input/output terminal; and
a third test circuit coupled to the first and the second bus lines, the third test circuit converting the first and the third test result signals supplied in parallel from the first and the second test circuits into serial signals and outputting the serial signals to the data input/output terminal in the first test mode, and the third test circuit performing a logic operation on the second and the fourth test result signals supplied in parallel from the first and the second test circuits to generate a fifth test result signal and outputting the fifth rest result signal to the data input/output terminal in the second test mode.

5. A device comprising:
a plurality of first memory cell arrays;
a plurality of first test groups each including corresponding ones of the first memory cell arrays;
a plurality of first test circuits each provided for a corresponding one of the first test groups, each of the first test circuits receiving in parallel first test result signals from the ones of the first memory cell arrays of the corresponding one of the first test groups, outputting in series the first test result signals to a first output node thereof in a first test mode, performing a first logic operation on the first test result signals to produce a second test result signal and outputting the second test result signal to the first output node thereof in a second test mode; and
a second test circuit including a plurality of first input nodes coupled respectively to the first output nodes of the first test circuits, the second test circuit outputting, in the first test mode, in series ones of the first test results that are supplied from the first test circuits and performing a second logic operation on the second test result signals that are supplied from the first test circuits to produce a third test result signal and outputting, in the second test mode, the third test result signal.

6. The device as claimed in claim 5, further comprising a plurality of first bus lines each coupled between the first output node of an associated one of the first test circuits and an associated one of the first input nodes of the second test circuit.

7. The device as claimed in claim 5, further comprising a plurality of second memory cell arrays, and wherein each of the first test groups further includes corresponding ones of the second memory cell arrays, each of the first test circuits receives in parallel fourth test result signals from the ones of the second memory cell arrays of the corresponding one of the first test groups, outputs in series the fourth test result signals to a second output node thereof in the first test mode, performs the first logic operation on the first and the fourth test result signals to produce the second test result signal, the second test circuit further includes a plurality of second input nodes coupled respectively to the second output nodes of the first test circuits, and outputs, in the first test mode, in series ones of the fourth test results that are supplied from the first test circuits.

8. The device as claimed in claim 7, further comprising a plurality of first bus lines each coupled between the first output node of an associated one of the first test circuits and an associated one of the first input nodes of the second test circuit and a plurality of second bus lines each coupled between the second output node of an associated one of the first test circuits and an associated one of the second input nodes of the second test circuit.

9. The device as claimed in claim 7, wherein the first memory cell arrays are arranged in a first direction, the second memory cell arrays are arranged in parallel to the first memory cell arrays, the corresponding ones of the first memory cell arrays and the corresponding ones of the second memory cell arrays of each of the first test groups are arranged in a second direction crossing the first direction.

10. The device as claimed in claim 9, further comprising a plurality of first regions each provided for an associated one of the first test groups, the first region being, in each of the first test groups, sandwiched between the corresponding ones of the first memory cell arrays and the corresponding ones of the second memory cell arrays, and wherein each of the first test circuits are arranged in the first region of a corresponding one of the first test groups.

11. The device as claimed in claim 10, wherein the second test circuit is arranged in one of the first regions.

12. The device as claimed in claim 5, further comprising:
a plurality of second memory cell arrays;
a second test group including the second memory cell arrays;
a third test circuit provided for the second test group, the third test circuit receiving in parallel fourth test result signals from the second memory cell arrays of the second test group, outputting in series the fourth test result signals to a first output node thereof in the first test mode, performing a third logic operation on the fourth test result signals to produce a fifth test result signal and outputting the fifth test result signal to the first output node thereof in the second test mode; and
a fourth test circuit coupled to the second test circuit and the third test circuit, outputting, in the first test mode, in series one of the first test result signals and one of the fourth test result signals that are supplied from the second test circuit and the third test circuit, respectively, and performing a fourth logic operation on the third test result signal and the fifth test result signal that are supplied from the second test circuit and the third test circuit, respectively, to produce a sixth test result signal and outputting, in the second test mode, the sixth test result signal.

13. The device as claimed in claim 5, wherein each of the first memory cell arrays includes a plurality of memory cells configured to store test data and a comparator unit comparing the test data of ones of the memory cells to produce the first test result signal.

14. A device comprising:
a first wiring; and
a first test circuit including:
a first circuit unit that outputs first signals in time series;
a second circuit unit that performs a first logical operation based on the first signals to generate a second signal; and
a first selection circuit that receives the first signals and the second signal, wherein
the first selection circuit outputs the first signals to the first wiring in time series in a first operation mode, and
the first selection circuit outputs the second signal to the first wiring in a second operation mode.

15. The device as claimed in claim 14, further comprising a second wiring, wherein
the first test circuit further includes a third circuit unit that outputs third signals to the second wiring in time series, and
the second circuit unit generates the second signal by performing the logical operation based on the first signals and third signals.

16. The device as claimed in claim 14 further comprising:
a plurality of third wirings;
a plurality of third test circuits each including:
a fourth circuit unit that outputs fourth signals in time series;
a fifth circuit unit that performs a second logical operation based on the fourth signals to generate a fifth signal; and
a second selection circuit that receives the fourth signals and the fifth signal, wherein
the second selection circuit outputs the fourth signals in time series to corresponding one of the third wirings in the first operation mode, and
the second selection circuit outputs the second signal to the corresponding one of the third wirings in the second operation mode; and
a second test circuit that includes a sixth circuit unit that performs a third logical operation based on the second signal and fifth signals to generate a sixth signal in the second operation mode.

17. The semiconductor memory device as claimed in claim 16 further comprising an output terminal, wherein the second test circuit supplies the sixth signal to the output terminal.
